(19) United States
(12) Patent Application Publication
(10) Pub. No.: US 2010/0017208 A1
(43) Pub. Date: Jan. 21, 2010

(54) INTEGRATED CIRCUIT FOR PROCESSING VOICE

(75) Inventors: Katsuya MARUYAMA, Tokyo (JP); Hideo NAKAHARA, Miyazaki (JP)

Correspondence Address: Studebaker & Brackett PC, One Fountain Square, 11911 Freedom Drive, Suite 750, Reston, VA, 20190, US

(73) Assignee: OKI ELECTRIC INDUSTRY CO., LTD., Tokyo (JP)

(21) Appl. No.: 12/174,068

(22) Filed: Jul. 16, 2008

(51) Int. Cl. G10L 15/00

(52) U.S. Cl. 704/246; 704/E15.001

(57) ABSTRACT

An improved integrated circuit for processing voice (speech) is provided. This is a voice LSI. The voice LSI reduces a voice output level to 0V if a speech segment is silent. This voice LSI can reduce a white noise.

### BACKGROUND OF THE INVENTION

1. Field of the Invention

The present invention relates to an integrated circuit for processing a voice or speech, and more particularly to such integrated circuit that converts a digital voice signal into an analog voice signal and outputs the resulting signal (referred to as “voice LSI”). The digital voice signal is for example stored in the ADPCM/PCM format.

2. Description of the Related Art

A conventional voice LSI generates (outputs) a voice data that includes a silent portion. Referring to FIG. 1 of the accompanying drawings, it should be assumed that “Honjitsuwa Yoitenkidesu” is pronounced. This is a Japanese sentence and means “It's fine today.” A typical voice LSI generates a voice data that includes an acoustic portion “Honjitsuwa”, a silent portion and an acoustic portion “Yoitenkidesu.” During the silent portion, the voice LSI also produces a white noise.

### SUMMARY OF THE INVENTION

Referring to FIG. 2 of the accompanying drawings, a voice data produced from the voice LSI 4 is amplified by an amplifier 6 and is issued from a speaker 8. The amplified voice data contains a white noise in both the acoustic portion and silent portion, but the white noise during the acoustic portion is not significant whereas the white noise during the silent portion is significant. In particular, if the output wave of the voice LSI is amplified at ½ VDD by the amplifier 6, the white noise contained in the silent portion becomes buzzing when it is issued from the speaker 8. This buzzing is significant.

Referring to FIG. 3A of the accompanying drawings, depicted is an output waveform of the voice LSI 4 prior to the amplification by the amplifier 6. FIG. 3B depicts the output waveform after the amplification by the amplifier 6.

One object of the present invention is to provide a voice LSI that produces little or no white noise during a silent portion.

Another object of the present invention is to provide a voice processing method that can reduce white noise during a silent portion.

According to one aspect of the present invention, there is provided an improved voice LSI that reduces a voice output level to 0V during a silent portion.

Because the voice output level (voltage) is reduced to 0V during the silent portion, a white noise will not be produced during the silent portion.

According to another aspect of the present invention, there is provided a voice LSI that includes a voice table for storing information about a plurality of speech segments that constitute a single speech. The voice LSI also includes a CPU for determining whether the speech segment in question is silent or not, on the basis of the information stored in the voice table. The CPU reduces an output voltage of the speech segment to a predetermined value if the speech segment is silent.

The CPU may determine whether a length of the speech segment is shorter than a predetermined time. The CPU may not reduce the output voltage of the speech segment when the length of the speech segment is shorter than the predetermined time even if the speech segment is silent.

The voice LSI may further include a pin for receiving a command that decides whether the CPU should reduce the output voltage of the speech segment. The command is given from outside.

The information stored in the voice table may indicate whether the CPU should reduce the output voltage of the speech segment.

The CPU may cause the output voltage value of the speech segment to return to an original voltage value (e.g., ½ VDD) from the reduced value after the reduced voltage value is maintained for a certain period.

The CPU may determine whether a next speech segment is also silent. The CPU may maintain the output voltage of the speech segment at the predetermined value (reduced value) if the next speech segment is also silent.

The predetermined value is a value that can eliminate a white noise during the silent speech segment.

According to still another aspect of the present invention, there is provided an improved method of processing a speech. The method includes providing a voice table that carries information about a plurality of speech segments. These speech segments constitute a single speech. The method also includes determining whether the speech segment in question is silent or not, on the basis of the voice table. The method also reduces an output voltage of the speech segment to a predetermined value if the speech segment is silent.

The method may determine whether a length of the speech segment is shorter than a predetermined time. The method may not reduce the output voltage of the speech segment when the length of the speech segment is shorter than the predetermined time even if the speech segment is silent.

The information in the voice table may indicate whether the method should reduce the output voltage of the speech segment.

The method may cause the output voltage value of the speech segment to return to an original voltage value (e.g., ½ VDD) after the reduced voltage value is maintained for a certain period.

The method may determine whether a next speech segment is also silent. The method may maintain the output voltage of the speech segment at the predetermined value (reduced value) if the next speech segment is also silent.

The predetermined value is a value that can eliminate a white noise during the silent speech segment.

### BRIEF DESCRIPTION OF THE DRAWINGS

The above-described and other objects, aspects and advantages of the present invention will be more clearly understood from the following detailed description when read in conjunction with the accompanying drawings, in which:

FIG. 1 illustrates a waveform (voltage) of an output voice generated by a conventional voice LSI;

FIG. 2 is a block diagram of a typical voice LSI and associated parts;

FIG. 3A illustrates an output waveform generated by a conventional voice LSI before the amplification;

FIG. 3B illustrates an output waveform after the amplification;

FIG. 4 illustrates an internal structure of a voice LSI according to a first embodiment of the present invention;

FIG. 5 is a voice table used in the voice LSI shown in FIG. 4;

FIG. 6 is a flowchart that shows the processing carried out by a CPU in the voice LSI shown in FIG. 4;

FIG. 7 illustrates an output waveform generated by the voice LSI shown in FIG. 4;

FIG. 8 is a flowchart that shows the processing carried out by a CPU in the voice LSI according to a second embodiment of the present invention;

FIG. 9 illustrates an output waveform generated by the voice LSI of the second embodiment;

FIG. 10 illustrates an internal structure of a voice LSI according to a third embodiment of the present invention;

FIG. 11 is a flowchart that shows the processing carried out by a CPU in the voice LSI according to the third embodiment of the present invention;

FIG. 12A illustrates an output waveform when a countermeasure to silence is not applied in the third embodiment;

FIG. 12B illustrates an output waveform when a countermeasure to silence is applied in the third embodiment;

FIG. 13 is a voice table used in the voice LSI of a fourth embodiment of the present invention;

FIG. 14 is a flowchart that shows the processing carried out by a CPU in the voice LSI according to the fourth embodiment of the present invention;

FIG. 15A illustrates an output waveform that should be compared with the output waveform generated by the voice LSI of the fourth embodiment;

FIG. 15B illustrates the output waveform generated by the voice LSI of the fourth embodiment;

FIG. 16 is a voice table used in the voice LSI of a fifth embodiment of the present invention;

FIG. 17A illustrates an output waveform that would be generated by the voice LSI of the first embodiment;

FIG. 17B illustrates the output waveform generated by the voice LSI of the fifth embodiment; and

FIG. 18 is a flowchart of the processing carried out by a CPU in the voice LSI according to the fifth embodiment of the present invention.

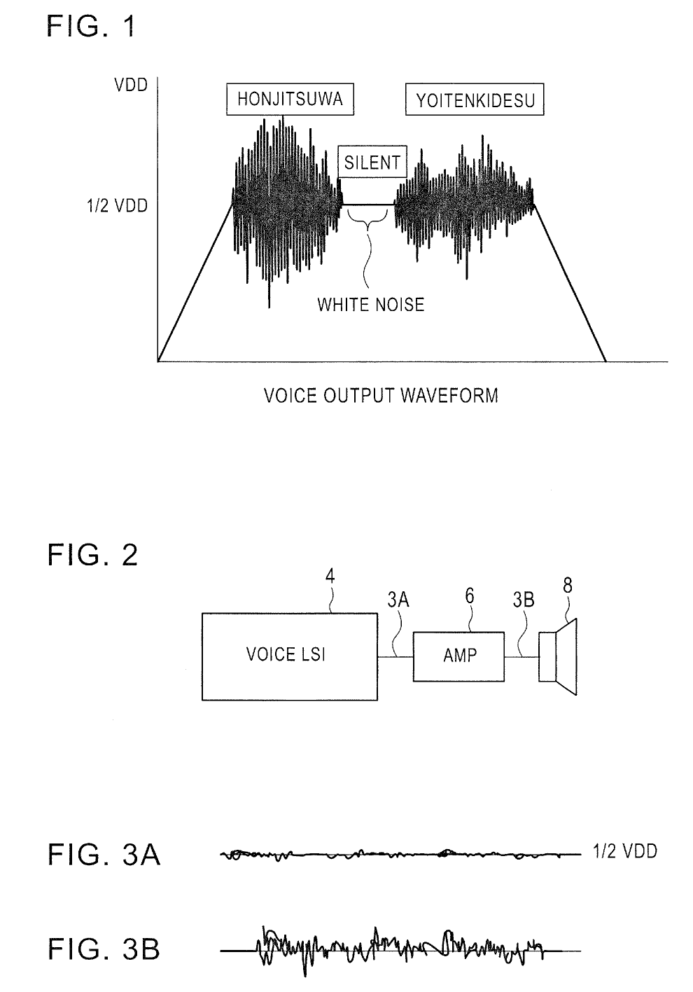

### DETAILED DESCRIPTION OF THE INVENTION

Preferred embodiments of the invention will now be described in detail with reference to the accompanying drawings.

### First Embodiment

Referring to FIG. 4 to FIG. 7, a voice LSI 10 of the first embodiment will be described.

As shown in FIG. 4, the voice LSI 10 includes a microcomputer part 11, a voice table 12 and a voice data region 13. The microcomputer part 11 has a CPU 111, a ROM 112, a RAM 113, and a digital/analog converter (D/A converter) 114.

The CPU 111 is a microprocessor, and the RAM 113 is used as a main storage device. The ROM 112 stores programs that are used by the CPU 111 to control the voice LSI 10. The D/A converter 114 converts a voice data in a digital signal format into a voice data in an analog signal format under the control of the CPU 111.

The voice table 12 stores various information about the voice data. In the illustrated embodiment, the stored information includes information about whether the voice data segment (speech segment) concerned is silent or not, and information about the output length (time) of that voice data segment. The voice data region 13 stores voice data in the form of digital signals. For example, the voice data is stored in the ADPCM/PCM format.

In the first embodiment, a single speech (single sentence) is dealt with. This single sentence is a Japanese sentence “watashiwakaishaindesu.” This means that I'm a business person. It also should be assumed that this Japanese sentence includes five speech segments, namely, “watashiwa”, “”(silence), “kaishain”, “”(silence) and “desu.”

Referring to FIG. 5, the detail of the voice table 12 is shown. The voice table 12 carries two information. One information is “kind of voice” and the other is “time.” The time is the output period of the voice segment concerned. For instance, 300 ms (milliseconds) is set to the first voice segment “watashiwa” and 100 ms is set to the subsequent silent voice segment. The D/A converter 114 reads the digital voice data from the voice data region 13 on the basis of the information in the voice table 12, and converts it into the analog voice data.

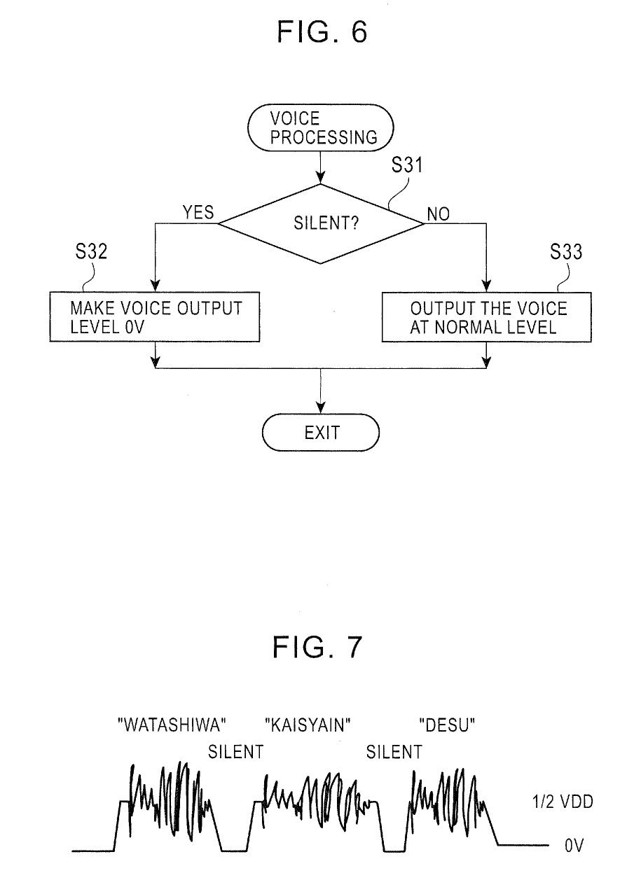

Referring to FIG. 6, the voice processing carried out by the voice LSI 10 (FIG. 4) is illustrated. This processing is primarily carried out by the CPU 111.

The CPU 111 determines whether a speech segment in question is silent or not (step S31). If the answer is yes, the CPU 111 reduces the voice output level (voltage level) to 0V from ½ VDD (step S32). On the other hand, if the speech segment is not silent, the CPU 111 does not change the voice output voltage and let it out as it is (step S33).

In the first embodiment, the CPU 111 retrieves the information of the speech segment (i.e., whether the speech segment is silent or not, and its duration) from the voice table 12 before the voice LSI 10 issues the voice (speech) output. If the retrieved information indicates that the speech segment is silent, the CPU 111 reduces the voltage level of that speech segment to 0V during the time of that speech segment. When the output voltage level is reduced to 0V from ½ VDD, then no output is made from the voice LSI 10. Accordingly, no white noise is produced.

The waveform of the output voice that has undergone the voice processing of the first embodiment is shown in FIG. 7. As depicted, the voltage is 0V when the voice is silent.

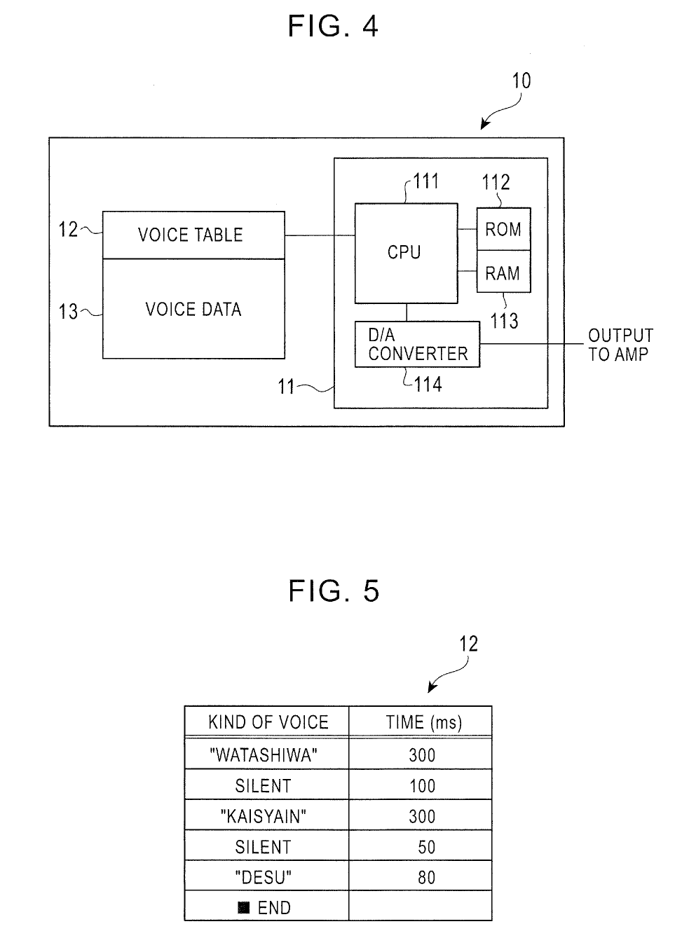

If the silent voice is issued from the voice LSI without the voice processing, it becomes a white noise upon amplification (see FIG. 3B). This is because the output level is unstable at or near the ½ VDD. In the first embodiment, such white noise is not generated because the unstable parts of the waveform are eliminated. Specifically, the waveform at or near the ½ VDD is eliminated during silence, i.e., the output level is reduced to 0V during silence. Thus, the cause of the white noise, which is the unstable voltage part, is eliminated in the first embodiment.

If the speech contains many silent segments, the power consumption of the voice LSI 10 is considerably reduced by the voice LSI 10 of the first embodiment because the output voltage is frequently reduced to 0V.

### Second Embodiment

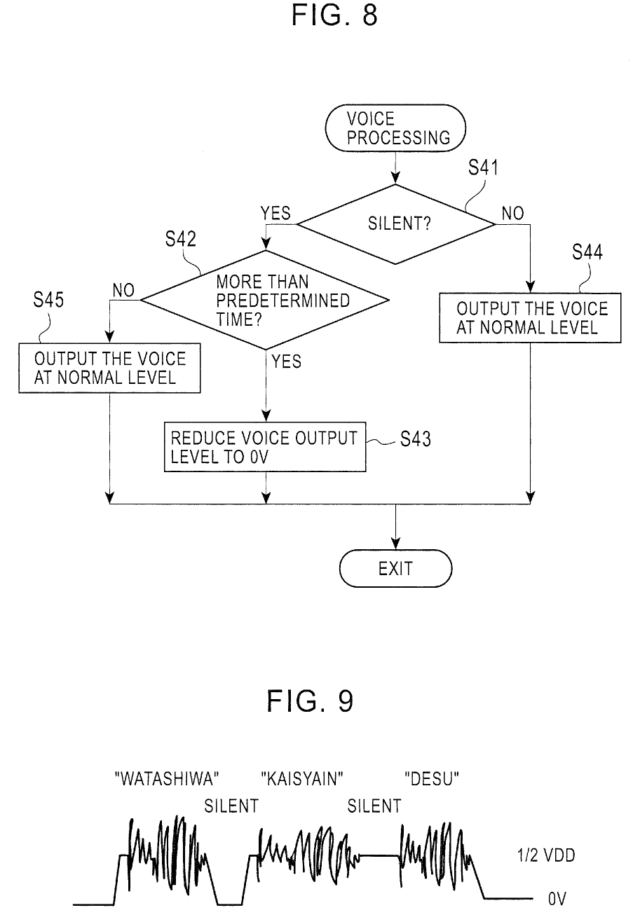

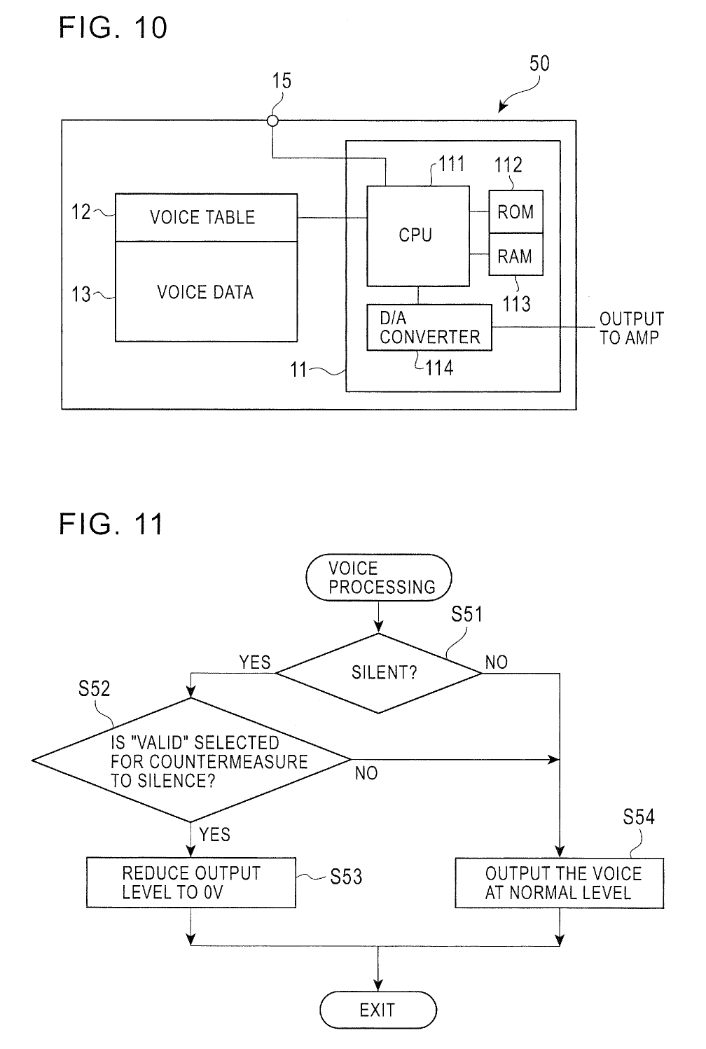

Referring to FIGS. 8 and 9, a voice LSI according to a second embodiment of the present invention will be described. The structure of the voice LSI of the second embodiment is similar to the voice LSI of the first embodiment (FIG. 4). Thus, the same reference numerals and symbols are used in the first and second embodiments. The voice processing performed by the CPU 111 in the second embodiment is different from that in the first embodiment.

FIG. 8 shows the voice processing of the second embodiment. The voice processing is primarily carried out by the CPU 111.

The CPU 111 determines whether the speech segment is silent or not (step S41). If the answer is yes, then the CPU 111 determines whether the time of the silence is shorter than a predetermined value (step S42). If the silence time is not shorter than the predetermined time, then the CPU 111 reduces the voice output voltage level to 0V (step S43). Otherwise, the CPU does not adjust the voice output voltage, and let it out as it is (step S44).

If the CPU 111 determines at the step S41 that the voice segment is not silent, then the CPU does not adjust the voice output voltage, and let it out as it is (step S45).

In the second embodiment, when the silence lasts the predetermined period (e.g., 100 ms) or more, then the CPU 111 reduces the output voltage from ½ VDD to 0V. If the silence is shorter than 100 ms, the CPU 111 maintains the output voltage (½ VDD) of that speech segment.

If the silent portion of the speech is short, the time available for reducing the voltage from ½ VDD to 0V is also short. If the voltage is reduced in such a case, it can create a problem called “POP noise.” In the second embodiment, as shown in FIG. 9, the silent portion of the speech between “watashiwa” and “kaishain” is 100 ms so that its output voltage is reduced to 0V, but the silent portion of the speech between “kaishain” and “desu” is 50 ms so that its output voltage is not reduced to 0V.

Therefore, the second embodiment can prevent not only the white noise but also the POP noise.

### Third Embodiment

Referring to FIG. 10, a third embodiment of the present invention will be described. This voice LSI 50 is similar to the voice LSI 10 of the first embodiment. Thus, like reference numerals and symbols are used in the first and third embodiments. A major difference is the provision of a pin 15 for receiving a command from outside. Other structure of the voice LSI is the same in the first and third embodiments.

A signal (or command) is supplied to the pin 15 from outside and transferred to the microcomputer part 11. This signal determines whether the countermeasure to the silence should be performed or not to a speech segment in question. The countermeasure to the silence is reducing the output voltage level of that speech segment to 0V in this embodiment.

FIG. 11 shows the voice processing of the third embodiment, which is primarily carried out by the CPU 111.

The CPU 111 determines whether the speech segment is silent or not (step S51). If the speech segment is silent, the CPU 111 determines whether the countermeasure to the silence should be performed or not (step S52). This determination is made on the basis of the command received at the pin 15. The command may be referred to as a “command to enable/disable the silence countermeasure.” If the command enables the silence countermeasure, the CPU 111 reduces the speech output voltage to 0V from ½ VDD (step S53). On the other hand, if the command indicates “no countermeasure,” then the CPU 111 does not adjust (reduce) the speech output voltage (step S54).

If it is determined at step s51 that the speech segment is not silent, then the CPU 111 does not adjust the output voltage of that speech segment (step S54).

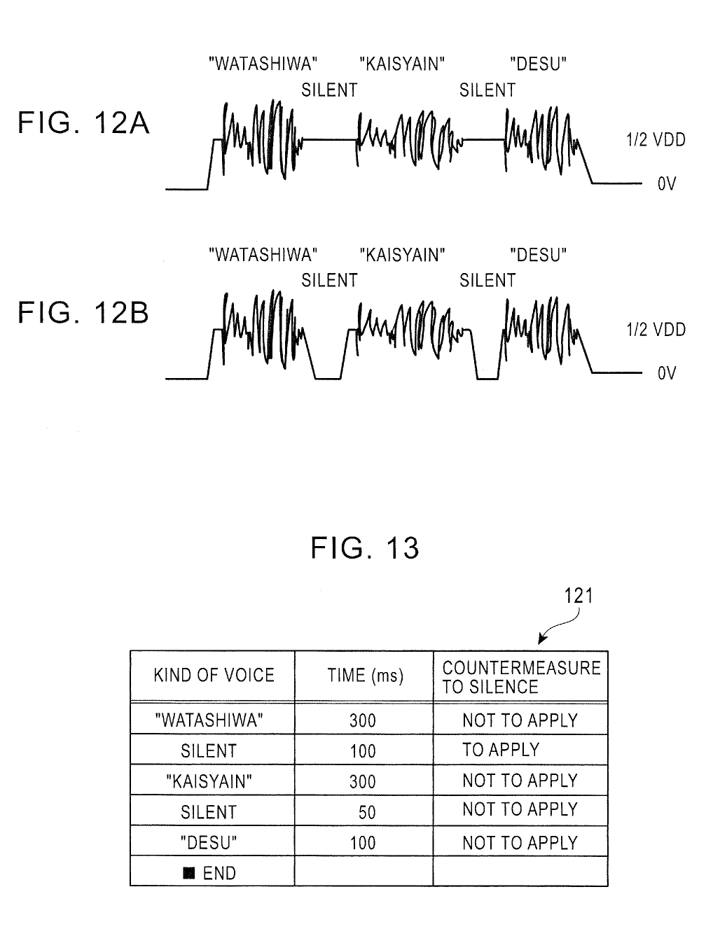

In the third embodiment, the voice LSI 50 is provided with the pin 15 for validating or invalidating the silence countermeasure. Upon receiving the command at the pin 15, the CPU 11 decides whether or not the silence countermeasure should be applied to the silent speech segment. FIG. 12A shows the output waveform when the step S52 determines that the silence countermeasure is invalid (should not be applied), and FIG. 12B shows the output waveform when the step S52 determines that the silence countermeasure is valid (should be applied).

Therefore, the third embodiment can selectively apply the output voltage adjustment to the speech segment, and the selection can be made easily.

### Fourth Embodiment

Referring to FIG. 13, a fourth embodiment of the present invention will be described. The fourth embodiment is similar to the first embodiment (FIG. 4), and like reference numerals and symbols are used in the first and fourth embodiments. A major difference lies in that the voice LSI of the fourth embodiment has a voice table 121 shown in FIG. 13. The voice table 121 contains additional information, as compared with the voice table 12 shown in FIG. 5. The additional information indicates whether the countermeasure to silence should be applied or not. The countermeasure to silence is to reduce the output voltage of a speech segment in question to 0V from ½ VDD. The voice table 121 contains the information on whether the speech segment in question is silent or not, and the information about the time of that speech segment.

In the voice table 121, “no countermeasure” is set to the speech segment “watashiwa”, and “countermeasure should be applied” is set to the subsequent speech segment (silent speech segment). “No countermeasure” is set to the second silent speech segment in this embodiment.

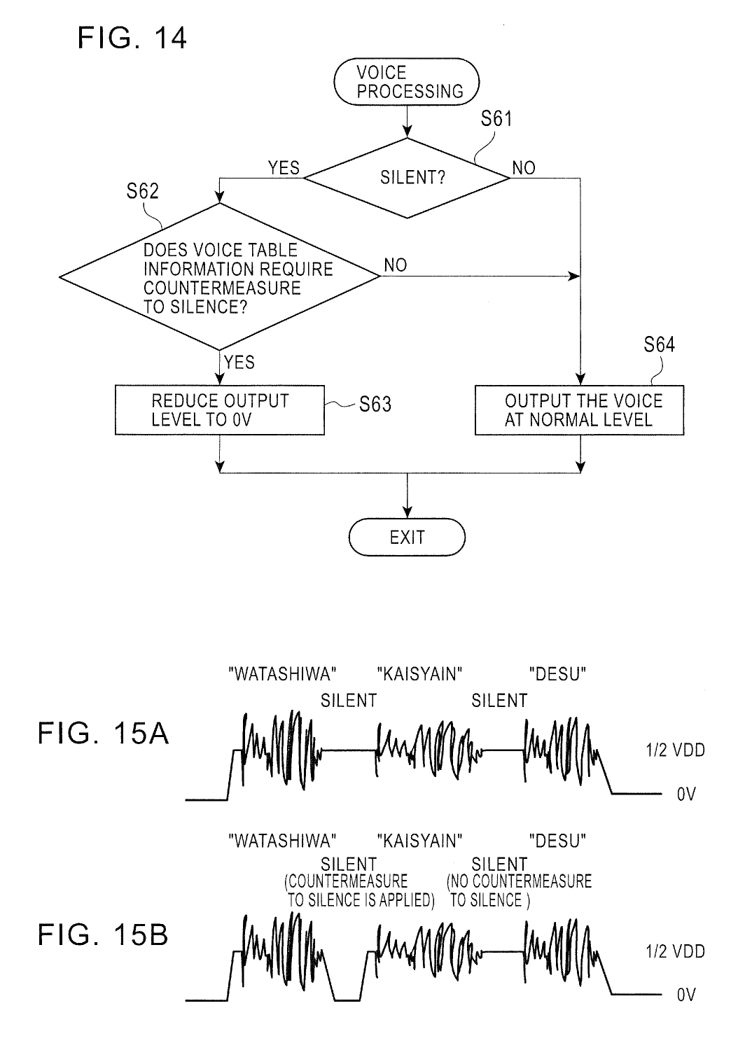

FIG. 14 shows the flowchart of the voice processing in the fourth embodiment. This voice processing is primarily carried out by the CPU 111 (FIG. 4).

The CPU 111 determines whether the speech segment is silent or not (step S61). If the answer is yes, then the CPU 111 determines whether the countermeasure to silence should be applied or not (step S62). This determination is made on the basis of the information stored in the third column of the voice table 121. If the third column of the voice table 121 indicates “to apply,” the CPU 111 reduces the output voice voltage to 0V (step S63). If the third column indicates “not to apply,” the CPU 111 does not apply the silence countermeasure (step S64).

If the step S61 determines that the speech segment is not silent, the CPU 111 does not apply the silence countermeasure to that speech segment (step S64).

In the fourth embodiment, whether the silence countermeasure should be applied or not is defined in the voice table 121. Thus, the CPU 111 refers to the voice table 121 before it applies the silence countermeasure even if the speech segment is silent.

FIG. 15A illustrates the output waveform generated by the conventional voice LSI.

FIG. 15B illustrates the output waveform generated by the voice LSI of the fourth embodiment. The countermeasure is applied to the first silent portion, but not applied to the second silent portion.

The fourth embodiment can selectively apply the silence countermeasure to the silent portion of the voice.

### Fifth Embodiment

Referring to FIG. 16, a fifth embodiment of the present invention will be described. The fifth embodiment is similar to the first embodiment (FIG. 4), and like reference numerals and symbols are used in the first and fifth embodiments. A major difference lies in that the voice LSI of the fifth embodiment has a voice table 122 shown in FIG. 16. The voice table 122 contains two continuous silent portions between the speech segments “watashiwa” and “kaishain,” as compared with the voice table 12 shown in FIG. 5. The fifth embodiment deals with a case where there are two successive silent portions.

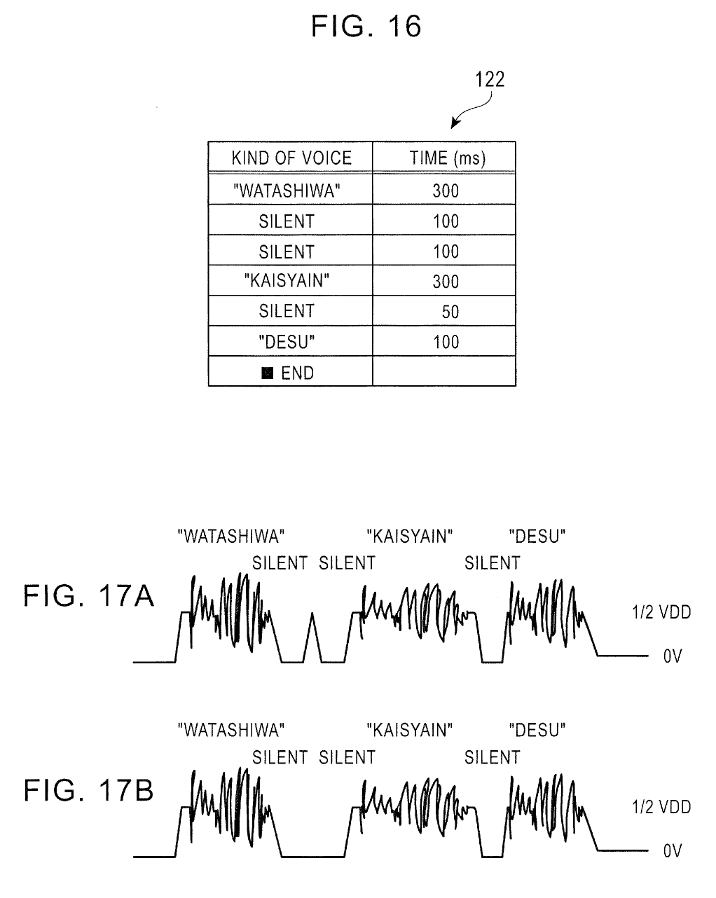

If the first embodiment (FIG. 8) is applied to such a case, the output waveform shown in FIG. 17A results. In FIG. 17A, the silence countermeasure is applied to the first silent portion and the second silent portion individually. As a result, the output voltage of the first silent speech segment drops from ½ VDD to 0V and returns to ½ VDD, and the same countermeasure is applied to the subsequent silent portion so that the output voltage of the second silent speech segment drops again from ½ VDD to 0V and returns to ½ VDD. Thus, the output voltage waveform has two “U” curves (or single “W” curve) between the speech segments “watashiwa” and “kaishain.” This is an unnecessary voltage adjustment.

The fifth embodiment deals with this problem. FIG. 17B depicts the output voltage waveform that results in the fifth embodiment. There is only one “U” curve in the waveform between the speech segments “watashiwa” and “kaishain.” Thus, as compared with FIG. 17A, unnecessary voltage adjustment is avoided.

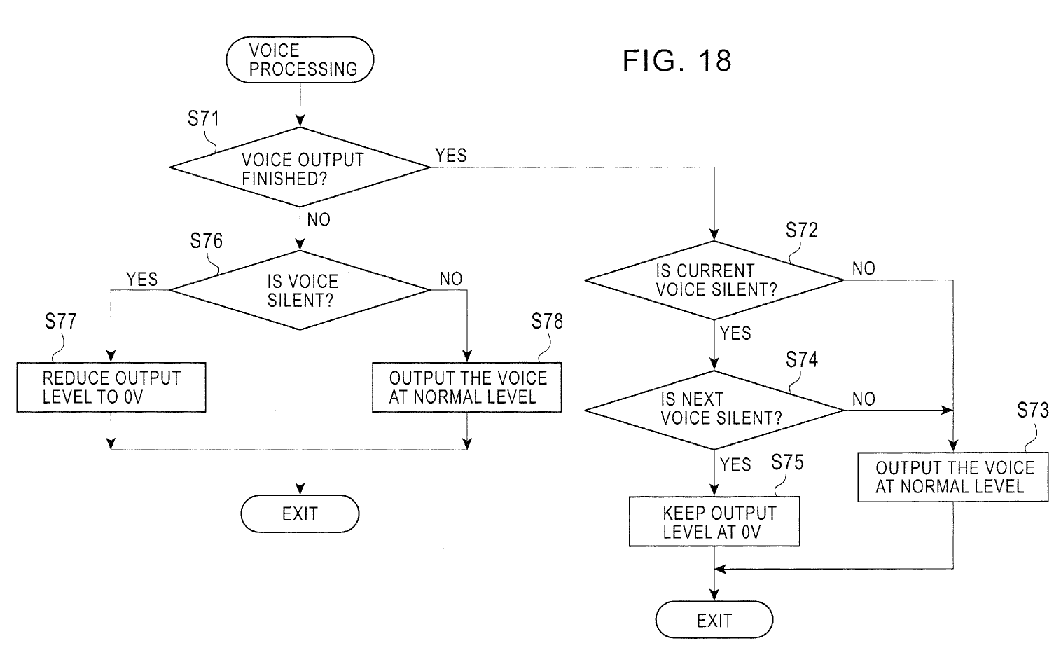

FIG. 18 shows the flowchart of the voice processing in the fifth embodiment. This voice processing is primarily carried out by the CPU 111 (FIG. 4).

The CPU 111 determines whether recognition (capturing) of the speech segment is finished (step S71). If the answer is yes, then the CPU 111 determines whether this speech segment is silent (step S72). If the speech segment is not silent, the CPU 111 does not change the output voltage of this speech segment (step S73). On the other hand, if the speech segment is silent, then the CPU 111 determines whether a next speech segment is also silent (step S74). The CPU 111 looks at the voice table 122 to know whether the next speech segment is silent or not. If the answer at the step S74 is no, the normal processing is applied (step S73), i.e., the silent countermeasure is applied to the first single silent portion and the output voltage is caused to drop to 0V and return to ½ VDD (step S73). On the other hand, if the second speech segment is also silent, then the CPU 111 does not allow the output voltage to return to ½ VDD from 0V during the silence countermeasure to the first silent speech segment. Instead, the CPU 111 maintains the output voltage at 0V so that the output voltage only returns to ½ VDD from 0V after the silent countermeasure to the second silent portion is finished (step S75). This modified voltage adjustment is carried out before the end of the silent countermeasure to the first silent portion, i.e., before the voltage returns to ½ VDD. Thus, the CPU 111 refers to the voice table 122 before it starts the processing to the second silent speech segment. This may be called “in advance referral to the voice table.”

If the step S71 determines that the speech segment recognition is not finished, the CPU determines whether the speech segment is silent or not (step S76). If the answer is yes, the CPU 111 reduces the output voltage of that speech segment to 0V (step S77). If the answer is no, the CPU 111 does not apply the silence countermeasure (step S78). The steps S76, S77 and S78 are similar to the steps S31, S32 and S33 in FIG. 6.

If the fifth embodiment, the CPU 111 reads the information from the voice table 122 before the voice processing to the first silent portion is finished. If this information indicates that the next speech segment is also silent, then the CPU 111 makes a modification to the silence countermeasure to the first silent portion. Specifically, the CPU 111 maintains the reduced output voltage at 0V until the countermeasure to the second silent portion is finished.

Unlike the first embodiment, the fifth embodiment does not always allow the output voltage to increase to ½ VDD from 0V upon finishing of the countermeasure to the silent speech segment. The fifth embodiment can combine the two successive silence countermeasure as shown in FIG. 17B. Accordingly, it is possible to avoid unnecessary increasing and decreasing of the output voltage.

The fifth embodiment can therefore carry out the voice processing (white noise elimination) in a more efficient manner. The fifth embodiment may also contribute to elimination of the POP noise.

It should be noted that if the time of a silent speech segment and/or that of a subsequent silent speech segment is short, these two successive silent segments may be combined to a single silent segment in the voice table. Then, the first embodiment can be used. However, the voice LSI (or the voice table) has a certain upper limit time for a silent speech segment. If the time of the silent speech segment exceeds that upper limit, then the voice table has to include two successive silent portions as shown in the table 122 of FIG. 16. In such a case, the fifth embodiment is used.

It should also be noted that the fifth embodiment only deals with a case where the single speech (or sentence) includes two successive silent speech segments, but the fifth embodiment may be applied to a speech that includes three or more silent speech segments.

The several embodiments of the present invention are described and illustrated, but the present invention is not limited to the described examples. For example, the output voltage is always reduced to 0V by the silence countermeasure in the above-described embodiments, but the output voltage may be reduced to 1/20 VDD or 1/10 VDD, as long as a white noise is eliminated by such voltage drop.

What is claimed is:

1. A voice LSI comprising:
a voice table for storing information about a plurality of speech segments that constitute a single speech; and
a CPU for determining whether the speech segment in question is silent or not, on the basis of the information stored in the voice table, and for reducing an output voltage of the speech segment to a predetermined value if the speech segment is silent.

2. The voice LSI according to claim 1, wherein the CPU determines whether a length of the speech segment is shorter than a predetermined time, and does not reduce the output voltage of the speech segment when the length of the speech segment is shorter than the predetermined time even if the speech segment is silent.

3. The voice LSI according to claim 1, further comprising a pin for receiving a command that decides whether the CPU should reduce the output voltage of the speech segment.

4. The voice LSI according to claim 1, wherein the information stored in the voice table indicates whether the CPU should reduce the output voltage of the speech segment.

5. The voice LSI according to claim 1, wherein the CPU causes the output voltage value of the speech segment to return to an original voltage value from the reduced value after the reduced voltage value is maintained for a certain period.

6. The voice LSI according to claim 1, wherein the CPU determines whether a next speech segment is also silent, and maintains the output voltage of the speech segment at the predetermined value if the next speech segment is also silent.

7. The voice LSI according to claim 1, wherein the single speech is a single sentence.

8. The voice LSI according to claim 1, wherein the predetermined value is a value that can eliminate a white noise during the speech segment in question.

9. The voice LSI according to claim 1, wherein the predetermined value is 0V.

10. The voice LSI according to claim 1, wherein the predetermined time is 50 milliseconds.
